(19) United States
(12) Patent Application Publication
(10) Pub. No.: US 2025/0327775 A1
(43) Pub. Date: Oct. 23, 2025

(54) OPTOMECHANICAL COMPONENT, MEASUREMENT DEVICE, ANDMEASUREMENT METHOD

(71) Applicant: Nippon Telegraph and Telephone Corporation, Tokyo (JP)

(72) Inventors: Motoki Asano, Tokyo (JP); Koji Sakai, Tokyo (JP); Riku Takahashi, Tokyo (JP); Hiroshi Yamaguchi, Tokyo (JP); Hajime Okamoto, Tokyo (JP)

(21) Appl. No.: 18/871,912

(22) PCT Filed: Aug. 2, 2022
(86) PCT No.: PCT/JP2022/029616

§ 371 Date: Dec. 5, 2024

(51) Int. Cl. G01N 29/24

(52) U.S. Cl. CPC G01N 29/2418; G01N 2291/014

(57) ABSTRACT

An opto-mechanical element includes, in a rod-shaped base having a circular outer shape, an optical resonance portion having a constant outer diameter, and a distal end portion having a conical one end side. A region from the distal end portion to part of the rod-shaped base is defined as a mechanical resonance portion capable of confining a mechanical vibration mode in this region. In addition, the opto-mechanical element may include a constricted portion formed on the other end side of the rod-shaped base. A diameter of the constricted portion is smaller than a diameter of the optical resonance portion. The optical resonance portion is formed between the constricted portion and the distal end portion. As a result of the constricted portion being provided, the optical resonance portion becomes an optical resonator in a whispering gallery mode.

### CROSS-REFERENCE TO RELATED APPLICATIONS

This application is a national phase entry of PCT Application No. PCT/JP2022/029616, filed on Aug. 2, 2022, which application is hereby incorporated herein by reference.

### TECHNICAL FIELD

Embodiments of the present invention relate to an opto-mechanical element including an optical resonator and a mechanical resonator, a measurement device, and a measurement method.

### BACKGROUND

In recent years, ultrahigh-sensitivity sensing by an opto-mechanical element using coupling between light and mechanical vibration has attracted attention. Sensing by such an opto-mechanical element does not require electrical reading and driving and can read change in mechanical vibration characteristics with light, and thus, has an advantage that it can be directly incorporated into a node of an optical network as an IoT element. In particular, a whispering gallery mode (WGM) optical resonator is capable of detecting minute displacement on the order of several femtometers by a strong optical confinement effect, and thus has been developed as an opto-mechanical element capable of detecting various external stimuli (Non Patent Literature 1).

Among them, a spherical or bottle type WGM optical resonator manufactured on a rod-shaped base such as an optical fiber enables analysis (measurement) at an arbitrary position as a probe in an environment such as a solution or a semi-solid that is difficult to be introduced to an element on a chip (Non Patent Literature 2 and Non Patent Literature 3).

### CITATION LIST

### Non Patent Literature

Non Patent Literature 1: M. R. Foreman et al., “Whispering gallery mode sensors”, Advances in Optics and Photonics, vol. 7, pp. 168-240, 2015.
Non Patent Literature 2: W. Yu et al., “Cavity optomechanical spring sensing of single molecules”, Nature Communications, DOI:10.1038, ncomms12311, 2016.
Non Patent Literature 3: M. Asano et al., “Free-space optomechanical liquid probes using a twin-microbottle resonator”, arXiv, 2203.14496, 2022.

### SUMMARY

### Technical Problem

However, in the above-described related art, spatial resolution is limited by a size (>40 μm) of the resonator, and thus, it is difficult to analyze an object smaller than the resonator, such as a microdroplet or a biological cell, with sufficient spatial resolution.

Embodiments of the present invention have been made to solve the above problem, and an object of embodiments of the present invention is to enable analysis of a minute object by an opto-mechanical element.

### Solution to Problem

An opto-mechanical element according to embodiments of the present invention includes, in a rod-shaped base having a circular outer shape, an optical resonance portion having a constant outer diameter, and a distal end portion having a conical one end side.

In addition, a measurement device according to embodiments of the present invention includes: an opto-mechanical element including, in a rod-shaped base having a circular outer shape, an optical resonance portion having a constant outer diameter, and a distal end portion having a conical one end side; and a measurement mechanism that measures change in optical resonance in the optical resonance portion.

In addition, a measurement method according to embodiments of the present invention measures optical response of a target object by measuring change in optical resonance in an optical resonance portion by using an opto-mechanical element which includes, in a rod-shaped base having a circular outer shape, an optical resonance portion having a constant outer diameter, and a distal end portion having a conical one end side, and in which the base incorporates an optical waveguide through which light is guided in an axial direction, using light guided by the optical waveguide and emitted from the distal end portion.

### Advantageous Effects

As described above, according to embodiments of the present invention, the rod-shaped base includes the optical resonance portion having a constant outer diameter and the distal end portion having a conical one end side, so that it is possible to analyze a minute object by the opto-mechanical element.

### BRIEF DESCRIPTION OF THE DRAWINGS

FIG. 1 is a configuration diagram illustrating a configuration of an opto-mechanical element according to a first embodiment of the present invention.

FIG. 2 is a configuration diagram illustrating another configuration of the opto-mechanical element according to the first embodiment of the present invention.

FIG. 3A is a photograph indicating a configuration of the opto-mechanical element according to the first embodiment of the present invention.

FIG. 3B is a configuration diagram illustrating a configuration of a measurement device according to the first embodiment of the present invention.

FIG. 3C is a characteristic diagram indicating a result of measurement using the measurement device according to the first embodiment.

FIG. 3D is a characteristic diagram indicating a result of measurement using the measurement device according to the first embodiment.

FIG. 4A is a configuration diagram illustrating a configuration of a measurement environment using the measurement device according to the first embodiment of the present invention.

FIG. 4B is a characteristic diagram indicating a result of measurement using the measurement device according to the first embodiment.

FIG. 5A is a configuration diagram illustrating a configuration of a measurement device according to a second embodiment of the present invention.

FIG. 5B is a configuration diagram illustrating a configuration of the measurement device according to the second embodiment of the present invention.

FIG. 6 is a configuration diagram illustrating a configuration of a measurement device according to a third embodiment of the present invention.

FIG. 7 is a configuration diagram illustrating a configuration of a measurement device according to a fourth embodiment of the present invention.

FIG. 8 is a configuration diagram illustrating a configuration of a measurement device according to a fifth embodiment of the present invention.

FIG. 9 is a configuration diagram illustrating a configuration of a measurement device according to a sixth embodiment of the present invention.

FIG. 10 is a configuration diagram illustrating a configuration of a measurement device according to a seventh embodiment of the present invention.

FIG. 11 is a configuration diagram illustrating a configuration of a measurement device according to an eighth embodiment of the present invention.

### DETAILED DESCRIPTION OF ILLUSTRATIVE EMBODIMENTS

Hereinafter, an opto-mechanical element according to embodiments of the present invention will be described.

### First Embodiment

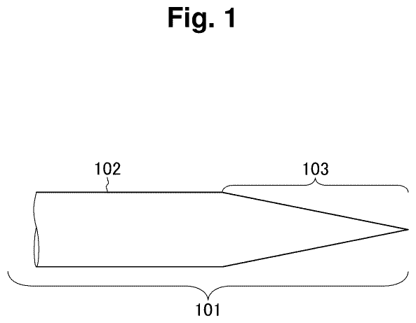

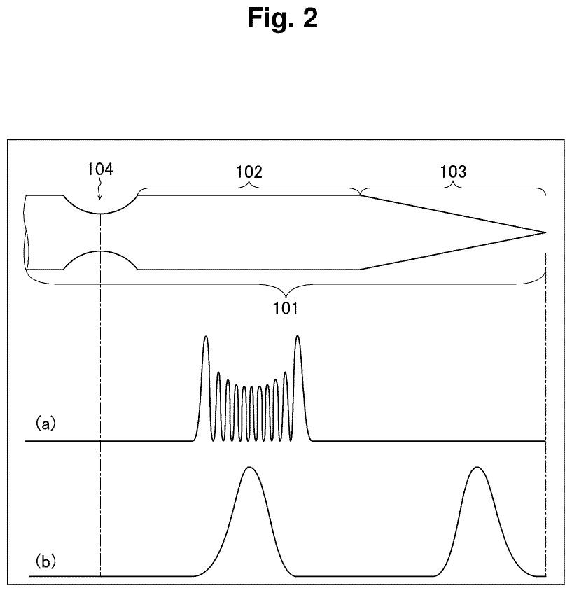

First, an opto-mechanical element according to a first embodiment of the present invention will be described with reference to FIGS. 1 and 2. The opto-mechanical element includes, in a rod-shaped base 101 having a circular outer shape, an optical resonance portion 102 having a constant outer diameter, and a distal end portion 103 having a conical one end side. A region from the distal end portion 103 to part of the base 101 is defined as a mechanical resonance portion capable of confining a mechanical vibration mode in this region.

In addition, as illustrated in FIG. 2, the opto-mechanical element can include a constricted portion 104 formed on the other end side of the base 101. A diameter of the constricted portion 104 is smaller than a diameter of the optical resonance portion 102. The optical resonance portion 102 is formed between the constricted portion 104 and the distal end portion 103. As a result of the constricted portion 104 being provided, the optical resonance portion 102 becomes an optical resonator in a whispering gallery mode.

As indicated in (a) and (b) in FIG. 2, as a result of distribution of the optical mode in the optical resonance portion 102 and the mechanical vibration mode in the mechanical resonance portion partially spatially overlapping each other, it is possible to use opto-mechanical coupling via a radiation pressure.

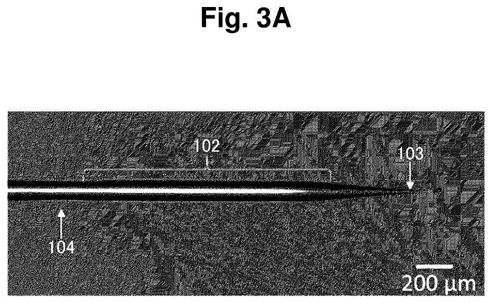

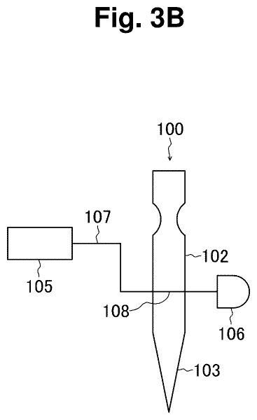

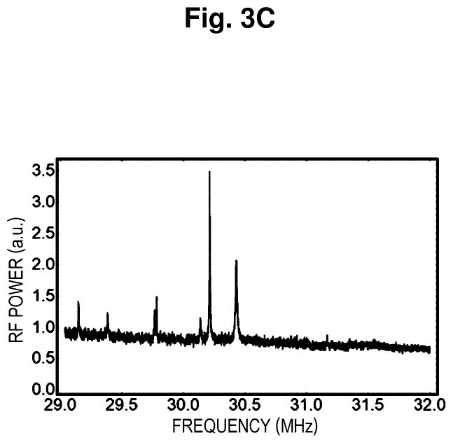

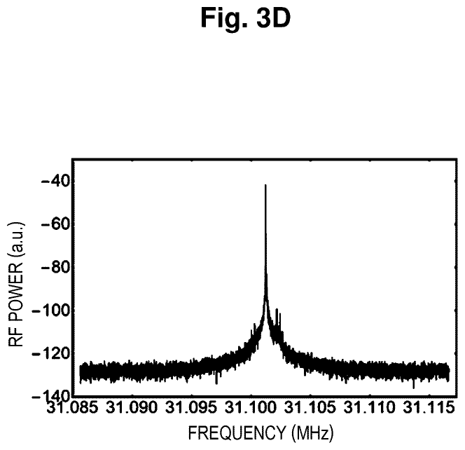

For example, an opto-mechanical element can be obtained by forming a needle structure and a constricted structure on a silica optical fiber by glass processing machine. A photograph of an actually manufactured opto-mechanical element is indicated in FIG. 3A.

Next, a measurement device according to the first embodiment will be described with reference to FIG. 3B. In this measurement device, an input/output portion 108 of an optical fiber 107 is disposed close to the optical resonance portion 102 of the opto-mechanical element 100. A light source 105 that emits laser light is connected to one end of the optical fiber 107, and a spectrum analyzer 106 is connected to the other end of the optical fiber 107. The light source 105, the spectrum analyzer 106, and the optical fiber 107 constitute a measurement mechanism that measures change in optical resonance in the optical resonance portion 102. In addition, the input/output portion 108 constitutes a photoexcitation mechanism that excites optical resonance of the optical resonance portion 102.

The input/output portion 108 is, for example, a region that allows leakage of light from a core by removing coating of the optical fiber 107 and further thinning a cladding layer. The input/output portion 108 is disposed close so as to enable optical coupling between the core of the optical fiber 107 and the whispering gallery mode of the optical resonance portion 102.

With the above configuration, it is possible to cause laser light from the light source 105 to enter the whispering gallery mode of the optical resonance portion 102 and to excite or read optical resonance in the optical resonance portion 102. This optical resonance undergoes periodic modulation in accordance with vibration of a mechanical resonant portion by opto-mechanical coupling. By reading this modulation effect from optical resonance, mechanical vibration is read by light. Conversely, it is also possible to excite the mechanical vibration by the radiation pressure of the resonated light. In addition, the above-described excitation and reading can be performed by using an optical element such as a prism.

By appropriately adjusting a laser frequency from the light source 105, a plurality of mechanical vibration signals having peaks around 30 MHz were obtained by the spectrum analyzer 106 (FIG. 3C). These correspond to spectra of the mechanical vibration mode oscillating in a radial direction excited by thermal fluctuations. Furthermore, by increasing optical power from the light source 105, oscillation of the vibration mode by parametric coupling of optical-mechanical vibration was observed (FIG. 3D). These experimental results indicate that an opto-mechanical element having a needle-like structure can detect and excite mechanical vibration by light.

Note that, in the above description, an example of using the mechanical vibration of the mechanical vibration mode (radial breathing mode) oscillating in the radial direction has been described. However, it goes without saying that other mechanical vibration modes such as a flexural mode corresponding to bending of the entire mechanical resonant portion and a torsional mode corresponding to torsion can be used.

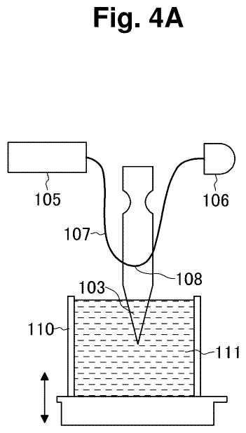

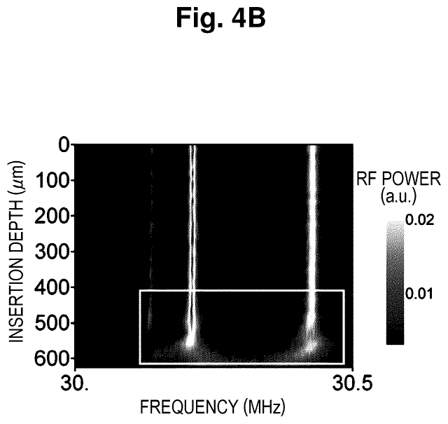

Viscoelastic characteristics of a target liquid (for example, water) can be measured by the measurement device described above. For example, as illustrated in FIG. 4A, a container 110 is raised using an electric stage (not illustrated), and the distal end portion 103 is inserted into water 111 stored in the container 110. Through this operation, as illustrated in FIG. 4B, a frequency shift of the mechanical vibration spectrum excited by thermal fluctuations is observed. This frequency shift results from a fact that mechanical vibration characteristics of the distal end portion 103 were changed by viscoelastic characteristics of water. This result indicates that environmental change of the distal end portion 103 can be detected by optically reading the mechanical vibration characteristics.

Similarly to a bottle structure in related art, the opto-mechanical element according to the first embodiment includes the optical resonance portion 102 in the whispering gallery mode between the constricted portion 104 and the distal end portion 103, and has a mechanical vibration mode oscillating in a radial direction of the base 101. The mechanical vibration mode has distribution extending not only to the optical resonance portion 102 but also to the distal end portion 103 and interacts with the whispering gallery mode via an optical radiation pressure, so that oscillation of the vibration mode by light and high sensitivity measurement can be implemented. The present inventors have succeeded in accurately forming a structure in which the constricted portion 104 and the distal end portion 103 are brought close to each other in the same base 101 through precise processing parameters. This structure does not require electrical control and can be expected to have a spreading effect on a wide range of technologies such as a minute actuator, a vibration sensor, and a biosensor all of which can be controlled by light.

### Second Embodiment

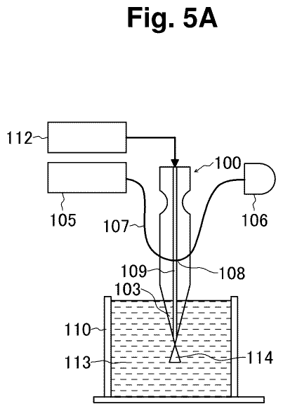

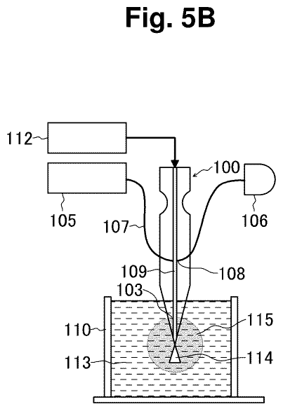

Next, a measurement device according to a second embodiment of the present invention will be described with reference to FIGS. 5A and 5B. The measurement device includes the optical fiber 107 including the opto-mechanical element 100, the light source 105, the spectrum analyzer 106, and the input/output portion 108, and the base 101 further includes an optical waveguide 109 through which light is guided in an axial direction. The opto-mechanical element 100 can be formed by processing a silica optical fiber. In addition, the measurement device includes an additional light source 112 that introduces light (laser light) into the optical waveguide 109.

The distal end portion 103 is inserted into a photoresponsive gel 113 stored in the container 110, and laser light is introduced from the additional light source 112 into the optical waveguide 109. The introduced laser light is guided through the optical waveguide 109, emitted from the distal end portion 103 and applied to the photoresponsive gel 113. Structural change and mass/viscoelastic change of the photoresponsive gel 113 can be measured by comparing change in vibration characteristics before and after light irradiation to the photoresponsive gel 113.

In addition, by putting a gelling initiator into the photoresponsive gel 113 stored in the container 110 and then irradiating the photoresponsive gel 113 with laser light emitted from the distal end portion 103, it is possible to measure the mass/viscoelastic change of the photoresponsive gel 113 (gel 115) in real time while controlling gelling process of a gel 115 of the photoresponsive gel 113 by light control by the additional light source 112 (FIG. 5B).

A measurement method using the measurement device according to the second embodiment described above measures light response of a target object by measuring change in optical resonance in the optical resonance portion 102 by using the opto-mechanical element which includes, in a rod-shaped base 101 having a circular outer shape, the optical resonance portion 102 having a constant outer diameter, and the distal end portion 103 having a conical one end side, and in which the base 101 incorporates an optical waveguide through which light is guided in an axial direction, using light guided in the optical waveguide and emitted from the distal end portion 103.

### Third Embodiment

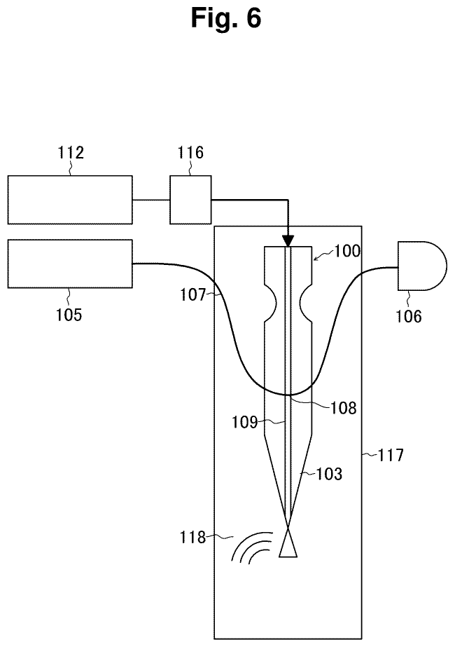

Next, a measurement device according to a third embodiment of the present invention will be described with reference to FIG. 6. This measurement device includes the opto-mechanical element 100, the light source 105, the spectrum analyzer 106, the optical fiber 107 including the input/output portion 108, and the additional light source 112. Also in this example, the opto-mechanical element 100 includes the optical waveguide 109 built in the base 101. In addition, the measurement device modulates intensity of light emitted from the optical waveguide 109 by a light intensity modulator 116 and then introduces the modulated light into the optical waveguide 109.

The opto-mechanical element 100 is stored in the container 117 together with a measurement target gas 118. In this state, the additional light source 112 and the light intensity modulator 116 introduce the intensity-modulated laser light into the optical waveguide 109. The introduced laser light is guided through the optical waveguide 109, emitted from the distal end portion 103 and applied to the gas 118.

Molecules of the gas 118 are heated according to absorption of the irradiated light, and repeatedly expand and contract according to an optical modulation frequency, and emit ultrasonic waves. Photoacoustic spectroscopy can be performed by reading the emitted ultrasonic waves from the mechanical vibration characteristics. The ultrasonic waves can also be read by mechanical vibration resonance by adjusting the optical modulation frequency to the vicinity of a resonance frequency of the mechanical vibration mode. In this example, a gas has been described, but the present invention is also applicable to a liquid or a solid, and is also applicable to photoacoustic spectroscopic imaging by precisely controlling the position of the opto-mechanical element 100.

### Fourth Embodiment

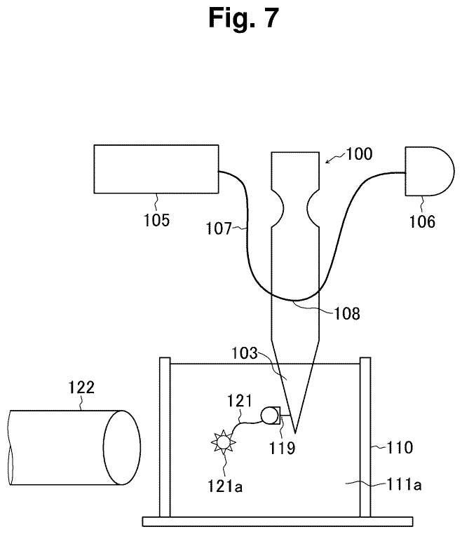

Next, a measurement device according to a fourth embodiment of the present invention will be described with reference to FIG. 7. This measurement device includes the opto-mechanical element 100, the light source 105, the spectrum analyzer 106, the optical fiber 107 including the input/output portion 108, and the additional light source 112. In this example, it is not necessary to incorporate the optical waveguide in the base 101. In this example, a protein antibody 119 is modified at the distal end portion 103.

The distal end portion 103 is inserted into a protein solution 111a stored in the container 110. The protein antibody 119 modified at the distal end portion 103 and protein 121 in the protein solution 111a are bound to each other, and by measuring change in vibration characteristics accompanying mass change of the distal end portion 103 by this binding, the protein 121 can be detected. By binding e fluorescent label 121a to the protein 121 in advance, it is possible to compare an adsorption amount and change in vibration characteristics by measuring luminance of the fluorescent label 121a by a fluorescence microscope 122 and comparing with evaluation of substance adsorption based on the measured luminance.

### Fifth Embodiment

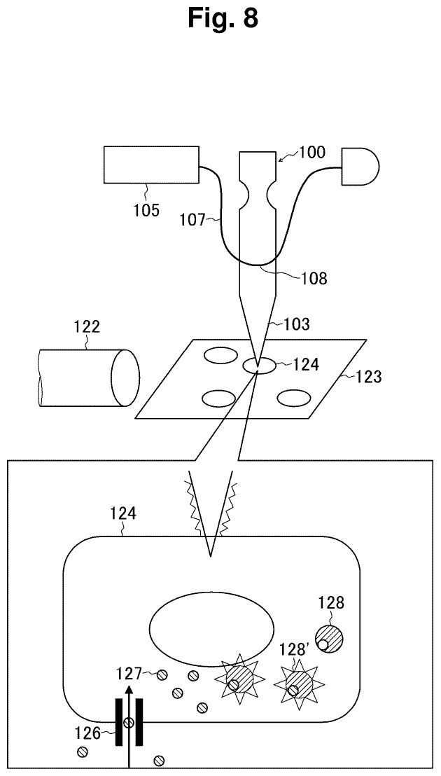

Next, a measurement device according to a fifth embodiment of the present invention will be described with reference to FIG. 8. This measurement device includes the opto-mechanical element 100, the light source 105, the spectrum analyzer 106, the optical fiber 107 including the input/output portion 108, and the additional light source 112. In this example, it is not necessary to incorporate the optical waveguide in the base 101.

First, the distal end portion 103 is brought into contact with a cell membrane surface of a cell 124 cultured on a glass plate 123. Alternatively, a distal end of the distal end portion 103 is inserted into the cell 124 to bring the cell 124 into contact with the opto-mechanical element 100. In this state, the laser light emitted from the light source 105 is injected into the opto-mechanical element 100 through the input/output portion 108, and the mechanical vibration mode is oscillated through opto-mechanical coupling. As a result, mechanical stimulation can be applied to the cell 124 that is in contact with the distal end portion 103.

In addition, by incorporating a calcium indicator 128 into the cell 124 in advance, inflow of calcium ions into the cell 124 by mechanical stimulation can be visualized. If an ion channel 126 on the cell membrane surface is opened by mechanical stimulation, calcium ions 127 flow into the cell 124. The inflowing calcium ions 127 bind to the calcium indicator 128 and emit fluorescence 128′, so that it is possible to time-lapse observe cellular response caused by mechanical stimulation by capturing fluorescence luminance with the fluorescence microscope 122. Calcium ions play an essential role in activity of cells, for example, protein synthesis, migration, and ignition phenomenon, and become an important index in evaluating response of cells by mechanical vibration.

### Sixth Embodiment

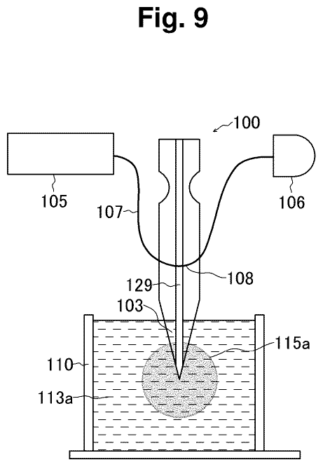

Next, a measurement device according to a sixth embodiment of the present invention will be described with reference to FIG. 9. This measurement device includes the optical fiber 107 including the opto-mechanical element 100, the light source 105, the spectrum analyzer 106, and the input/output portion 108. Further, the base 101 has a cylindrical shape and includes a hollow portion 129 penetrating the base 101 in an axial direction, at the axial center of the base 101.

For example, an initiator that induces gelling reaction is added to a gelling solution 113a stored in the container 110 via the hollow portion 129. The initiator is injected into the gelling solution 113a from the distal end of the distal end portion 103, and thus, the gelling reaction is started around the distal end of the distal end portion 103, and a gel 115′ is formed. Thus, the periphery of the distal end portion 103 exhibits mass change and viscoelastic change, and the vibration mode changes according to the mass change and the viscoelastic change. The vibration mode thus changed is measured by the measurement device.

### Seventh Embodiment

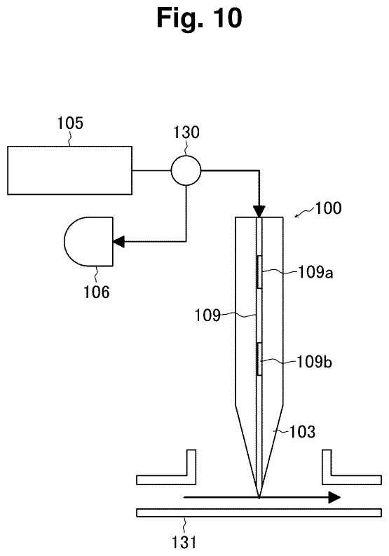

Next, a measurement device according to a seventh embodiment of the present invention will be described with reference to FIG. 10. The measurement device includes the optical fiber 107 including the opto-mechanical element 100, the light source 105, the spectrum analyzer 106, and the input/output portion 108, and the base 101 further includes an optical waveguide 109 through which light is guided in an axial direction. The opto-mechanical element 100 can be formed by processing a silica optical fiber. In addition, the measurement device includes a first distributed Bragg reflection portion 109a and a second distributed Bragg reflection portion 109b by grating in the optical waveguide 109. The measurement device includes the light source 105, the spectrum analyzer 106, and an optical circulator 130.

If the other end of the opto-mechanical element 100 is fixed by a clamp, or the like, a bending mechanical vibration mode similar to that of a cantilever can be used. If the optical resonance portion 102 is bent by the bending mechanical vibration mode, reflectances of the first distributed Bragg reflection portion 109a and the second distributed Bragg reflection portion 109b change. A laser having an optical resonance frequency of the optical resonance portion by the first distributed Bragg reflection portion 109a and the second distributed Bragg reflection portion 109b is introduced from the light source 105 into the optical waveguide 109. In this state, if the optical resonance portion 102 is bent in the bending mechanical vibration mode, modulation of the optical resonance frequency is measured by the spectrum analyzer 106. As described above, by measuring modulation of the optical resonance frequency, information on the mechanical vibration characteristics can be obtained. For example, by inserting the distal end portion 103 of the measurement device into a fluid flowing in a flow path 131, strength of the flow can be read from change in the mechanical vibration frequency.

### Eighth Embodiment

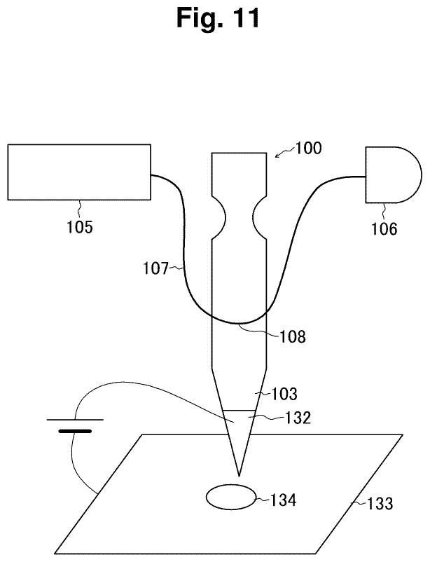

Next, a measurement device according to an eighth embodiment of the present invention will be described with reference to FIG. 11. This measurement device includes the optical fiber 107 including the opto-mechanical element 100, the light source 105, the spectrum analyzer 106, and the input/output portion 108. In this example, it is not necessary to incorporate the optical waveguide in the base 101. In this example, a covering layer 132 covering the distal end portion 103 is provided. The covering layer 132 is made of a material different from the base 101 and is made of, for example, a conductive material.

For example, an object 134 is disposed on a conductive plate 133, and the distal end portion 103 covered with the covering layer 132 is brought into contact with the object 134. In this state, by applying a voltage between the covering layer 132 and the plate 133, electric stimulation can be applied to the object 134. Mass change and viscoelastic change according to the electrical stimulation of the object 134 to which the electrical stimulation is applied can be measured from change in mechanical vibration characteristics of the opto-mechanical element 100.

As described above, according to embodiments of the present invention, the rod-shaped base includes the optical resonance portion having a constant outer diameter and the distal end portion having a conical one end side, so that it is possible to analyze a minute object by the opto-mechanical element.

Note that it is obvious that the present invention is not limited to the embodiments described above, but can be modified and combined in many ways by a person with ordinary knowledge in the art within the technical idea of the present invention.

### REFERENCE SIGNS LIST

101 Base
102 Optical resonance portion
103 Distal end portion

1-8. (canceled)

9. An opto-mechanical element comprising:
in a rod-shaped base having a circular outer shape, an optical resonance portion having a constant outer diameter; and
in the rod-shaped base, a distal end portion having a conical shape on a first end side of the rod-shaped base.

10. The opto-mechanical element according to claim 9, further comprising:
a constricted portion on a second end side of the rod-shaped base, the constricted portion having a diameter smaller than a diameter of the optical resonance portion,
wherein the optical resonance portion is an optical resonator in a whispering gallery mode.

11. The opto-mechanical element according to claim 10, wherein the optical resonance portion is between the constricted portion and the distal end portion.

12. The opto-mechanical element according to claim 10, wherein
the rod-shaped base incorporates an optical waveguide through which light is guided in an axial direction.

13. The opto-mechanical element according to claim 10, wherein
the rod-shaped base has a cylindrical shape.

14. The opto-mechanical element according to claim 10, further comprising:
a covering layer made of a material different from a material of the rod-shaped base and covering the distal end portion.

15. The opto-mechanical element according to claim 9, wherein
the rod-shaped base incorporates an optical waveguide through which light is guided in an axial direction.

16. The opto-mechanical element according to claim 9, wherein
the rod-shaped base has a cylindrical shape.

17. The opto-mechanical element according to claim 9, further comprising:
a covering layer made of a material different from a material of the rod-shaped base and covering the distal end portion.

18. A measurement device comprising:
an opto-mechanical element including:
in a rod-shaped base having a circular outer shape, an optical resonance portion having a constant outer diameter; and
in the rod-shaped base, a distal end portion having a conical shape on a first end side of the rod-shaped base; and
a measurement mechanism configured to measure change in optical resonance in the optical resonance portion.

19. The measurement device according to claim 18, further comprising:
a photoexcitation mechanism configured to excite optical resonance of the optical resonance portion.

20. A measurement method, comprising:
measuring optical response of a target object by measuring change in optical resonance in an optical resonance portion of an opto-mechanical element, wherein the opto-mechanical element includes:
in a rod-shaped base having a circular outer shape, an optical resonance portion having a constant outer diameter; and
in the rod-shaped base, a distal end portion having a conical shape on a first end side of the rod-shaped base, wherein the rod-shaped base incorporates an optical waveguide through which light is guided in an axial direction, and wherein measuring optical response of the target object by measuring change in the optical resonance in the optical resonance portion of the opto-mechanical element comprises using light guided through the optical waveguide and emitted from the distal end portion.

21. The measurement method according to claim 20, wherein the opto-mechanical element further comprises:
a constricted portion on a second end side of the rod-shaped base, the constricted portion having a diameter smaller than a diameter of the optical resonance portion,
wherein the optical resonance portion is an optical resonator in a whispering gallery mode.

22. The measurement method according to claim 20, wherein
the rod-shaped base has a cylindrical shape.

23. The measurement method according to claim 20, wherein the opto-mechanical element further comprises:
a covering layer made of a material different from a material of the rod-shaped base and covering the distal end portion.
